(19) United States
(12) Patent Application Publication
(10) Pub. No.: US 2022/0245300 A1
(43) Pub. Date: Aug. 4, 2022

(54) METHOD AND SYSTEM FOR CONSTRUCTING STATISTICAL EMULATORS FOR RESERVOIR SIMULATION MODELS WITH UNCERTAIN INPUTS

(71) Applicant: ROXAR SOFTWARE SOLUTIONS AS, Stavanger (NO)

(72) Inventor: Rafel Marc BORDAS, Oxford (GB)

(73) Assignee: ROXAR SOFTWARE SOLUTIONS AS, Stavanger (NO)

(21) Appl. No.: 17/625,242

(22) PCT Filed: Jul. 19, 2019
(86) PCT No.: PCT/EP2019/069577

§ 371 Date: Jan. 6, 2022

(51) Int. Cl. G06F 30/20; G01V 99/00; E21B 41/00

(52) U.S. Cl. CPC G06F 30/20; G06F 2111/08; E21B 41/00; G01V 99/005

(57) ABSTRACT

A method for generating a stochastic emulation model is disclosed. In an embodiment, the method uses a computer (100) having a processor (110) configured to execute commands stored on a non-transitory memory element (120), the non-transitory memory element (120) having an emulation module (124). The method includes generating, by the emulation module (124), a stochastic emulation model (3) from the output of a deterministic emulation model (η).

### TECHNICAL FIELD

The embodiments described below relate to systems for statistical emulations, the embodiments further relate to systems for statistical emulations for simulation models.

### BACKGROUND

Statistical emulators represent a general type of statistical model used in the context of making the maximum use of the outputs of complicated computer-based simulation models. Reservoir simulators are slow when compared with emulators and require considerably more computer resources than emulators. Emulators provide a fast approximation of the simulation model and are used when each evaluation of the simulation model is computationally expensive. Normally, the inputs to the simulation model are fixed, chosen, values and the output is expected to be deterministic. In this setting, emulators have proven to be useful tools used to accelerate both history matching and optimization of oil & gas reservoir models.

In some reservoir simulation applications, inputs to the simulation model are random variables whose values are defined as probability distributions. The most common example of this is found in an optimization under uncertainty workflow. In these workflows geological inputs are random variables of known distribution whilst the control inputs being optimized are defined values. The uncertain inputs must be sampled to be able to run the simulation model. This results in the output of the simulation model having a degree of randomness and, in effect, the model with control inputs becomes a stochastic simulation model.

Stochastic emulators have been developed that can approximate stochastic simulation models. Such emulators typically require many simulation evaluations (‘runs’) to accurately capture the randomness in the simulation model. These emulators have been used to accelerate workflows where the model is stochastic owing to the presence of uncertain inputs. However, the large number of runs required can make analyzing these models difficult even when using emulation techniques.

Closed loop reservoir management using simulation models is an important method used to determine the most beneficial way to develop oil & gas fields. It is a combination of model-based optimization and data assimilation. In a closed loop system production measurements and geological measurements are used with data assimilation algorithms to update geological parameters in reservoir simulation models. Once the model parameters are updated the reservoir model can be used to optimize production controls, such as well trajectories and bottom hole pressures. The optimized production controls are used to define the field development plan and applied to the real reservoir. As new measurements become available, the process is repeated.

After the measurements are assimilated into the reservoir model, the estimated parameters will still have a degree of uncertainty associated with them. Few optimization methods allow uncertainties in the model to be accounted for and the utility of any field development decision is greatly affected by uncertainties. Thus, a method for constructing stochastic emulators may be required that can produce high quality emulators for fewer runs than is currently possible. The stochastic emulators may be used in a Bayesian optimization workflow to allow optimization of reservoir control parameters under geological uncertainty.

Existing methods for generating stochastic emulation models are inefficient and ineffective, typically failing to accurately emulate the simulation models the emulation models are supposed to represent. In part, this is due to each design point being treated independently and failing to capitalize on relationships between the various design points.

Accordingly, there is a need for improving the efficiency of methods that allow for optimization of reservoir models under uncertainty.

### SUMMARY

A method for generating a stochastic emulation model is disclosed. In an embodiment, the method uses a computer (100) having a processor (110) configured to execute commands stored on a non-transitory memory element (120), the non-transitory memory element (120) having an emulation module (124). The method includes generating, by the emulation module (124), a stochastic emulation model (β) from the output of a deterministic emulation model (η).

A computer system (100) for generating a stochastic emulation model is disclosed. In an embodiment, the computer system (100) has a processor (110) configured to execute commands stored on a non-transitory memory element (120), the non-transitory memory element (120) having an emulation module (124). The emulation module is configured to generate a stochastic emulation model (β) from the output of a deterministic emulation model (η).

### Aspects

According to an aspect, a method for generating a stochastic emulation model, using a computer (100) having a processor (110) configured to execute commands stored on a non-transitory memory element (120), the non-transitory memory element (120) having an emulation module (124) is disclosed. The method includes generating, by the emulation module (124), a stochastic emulation model (β) from the output of a deterministic emulation model (η).

Preferably, the generating a stochastic emulation model (β) from the output of a deterministic emulation model (η) includes determining, by the emulation module (124), a partial output (γᵢ).

Preferably, the generating a stochastic emulation model (β) from the output of a deterministic emulation model (η) further includes determining, by the emulation module (124), at least one building function (γ) based on one or more of sample outputs of the deterministic emulation model (η) and the partial output (γᵢ).

Preferably, the determining a partial output (γᵢ) includes determining the partial output (γᵢ) by aggregating all outputs of the deterministic emulation model (η) from inputs of a single control design point (xᵢ) and all geologic random points of all geologic random variables (Y) used in the stochastic emulation model (β), wherein the generating, by the emulation module (124), a stochastic emulation model (β) from the output of a deterministic emulation model (η) comprises using, by the emulation module (124), the partial output (γᵢ) to generate the stochastic emulation model (β).

Preferably, the generating a stochastic emulation model (β) from the output of a deterministic emulation model (η), further includes, determining, by the emulation module (124), a trend of the partial output (γᵢ), wherein the generating, by the emulation module (124), a stochastic emulation model (β) from the output of a deterministic emulation model (η) includes using, by the emulation module (124), the trend of the partial output (γᵢ) to generate the stochastic emulation model (β).

Preferably, the trend of the partial output (γᵢ) is one or more of an average of the partial output (γ̅ᵢ), a variance of the partial output (var(γᵢ), a standard deviation of the partial output (SD(γᵢ)), a maximum of the partial output (max(γᵢ)), and a minimum of the partial output (min(γᵢ)).

Preferably, the determining, by the emulation module (124), at least one building function (γ), further includes accounting for the trend of the partial output (γᵢ).

Preferably, the generating a stochastic emulation model (β) from the output of a deterministic emulation model (η) further includes accounting for a trend in building function (γ) when determining, by the stochastic emulation module (124), the stochastic emulation model (β) based on the building function (γ).

Preferably, the method for generating a stochastic emulation model (β) further includes generating, by a simulation module (122), a deterministic simulation model (f(x,y)) from a stochastic simulation model (f(x,Y)) by providing fixed samples, y, for the random variables Y to the stochastic simulation module (f(x,Y)).

Preferably, the method for generating a stochastic emulation model further includes generating, by the emulation module (124), the deterministic emulation model (η) from the deterministic simulation model (f(x,y)).

Preferably, the method further includes determining or receiving, by the emulation module (124), data representing at least one control design point (x) and data representing at least one geologic random point (y) and selecting, by the emulation module (124), from the at least one geologic random point (y), at least one sample geologic random point (yₛₐₘₚₗₑ), wherein the output of the deterministic emulation model (η) is at least one output from inputs of the at least one control design point (x) and the at least one sample geologic random point (yₛₐₘₚₗₑ).

Preferably, the at least one geologic random point (y) is a set of points representing a random distribution.

Preferably, the at least one geologic random point (y) represents a parameter in a model that is difficult to measure or determine, the random distribution representing known, measured or estimated variation in the parameter.

Preferably, the method further includes updating, by the emulation module (124), the stochastic emulation model (β), using emulation update techniques, to generate an updated stochastic emulation model (β_{new}), wherein the emulation update techniques account for the stochastic emulation model (β).

Preferably, the updating, by the emulation module (124), the stochastic emulation model (β) further includes determining, by the emulation module (124), a new building function (γ_{new}) based on a new deterministic emulation model (η_{new}), determining, by the emulation module (124), new partial outputs (γ_{new,i}) from the new building function (γ_{new}), wherein the stochastic emulation model (β) is updated based on the partial outputs (γ_{new,i}).

Preferably, the method further includes determining, by the emulation module (124), another partial output (γₛ) of the building function (γ), wherein the determining, by the emulation module (124), a partial output (γᵢ) of the building function (γ), further comprises transmitting, by the emulation module (124), data representing the building function (γ) and data representing input variables for generating the partial output (γᵢ) to a processing element of a parallel processing system, and wherein the determining, by the emulation module (124), another partial output (γₛ) of the building function (γ) further comprises transmitting, by the emulation module (124), data representing the building function (γ) and data representing different input variables for generating the another partial output (γₛ) to another processing element of a parallel processing system.

Preferably, the stochastic emulation model and the deterministic emulation model are models of a simulation model of a reservoir.

Preferably, the method further includes determining, by the emulation module (124), a new deterministic emulation model (η_{new}), by determining, by the simulation module (122), a new deterministic simulation model (f(x,y,)_{new}) from the stochastic simulation model (f(x,Y)), and determining, using the emulation module (124) a new deterministic emulation model (η_{new}) from the new deterministic simulation model (f(x,y,)_{new}).

Preferably, the method further includes generating, by the emulation module (124) an updated stochastic emulation model (β_{new}), based on the new deterministic emulation model (η_{new}) and a prior stochastic emulation model (β).

Preferably the generating, by the emulation module (124) an updated stochastic emulation model (β_{new}), based on the new deterministic emulation model (η_{new}), further includes determining one or more of a new or updated building function (γ_{new}) and a new or updated partial output (γ_{new,i}).

According to an aspect, a computer system (100) for generating a stochastic emulation model, having a processor (110) configured to execute commands stored on a non-transitory memory element (120), the non-transitory memory element (120) having an emulation module (124) is disclosed. The emulation module (124) is configured to generate a stochastic emulation model (β) from the output of a deterministic emulation model (η).

Preferably, the emulation module (124) is further configured to determine a partial output (γᵢ).

Preferably, the emulation module (124) is further configured to determine at least one building function (γ) based on one or more of sample outputs of the deterministic emulation model (η) and the partial output (γ).

Preferably, the emulation module (124) is further configured to generate the partial output (γᵢ) by aggregating all outputs of the deterministic emulation model (η) from inputs of a single control design point (xᵢ) and all geologic random points of all geologic random variables (y) used in the stochastic emulation model (|), and generate the stochastic emulation model (β) based on the partial output (γ).

Preferably, the emulation module (124) is further configured to determine, by the emulation module (124), a trend of the partial output (γᵢ), and generate the stochastic emulation model (β) based on the trend of the partial output (γᵢ).

Preferably, the trend of the partial output (γᵢ) is one or more of an average of the partial output (γ̅ᵢ), a variance of the partial output (var(γᵢ), a standard deviation of the partial output (SD(γᵢ)), a maximum of the partial output (max(γᵢ)), and a minimum of the partial output (min(γᵢ)).

Preferably, the emulation module (124) is further configured to determine at least one building function (γ) based on the trend of the partial output (γᵢ).

Preferably, the emulation module (124) is further configured to determine the stochastic emulation model (β) based on one or more of the building function (γ) and a trend in the building function (γ).

Preferably, the computer system (100) further including a simulation module (122), the simulation module (122) configured to generate a deterministic simulation model (f(x,y)) from a stochastic simulation model (f(x,Y)) by providing fixed samples, y, for the random variables Y to the stochastic simulation module (f(x,Y)).

Preferably, the emulation module (124) is further configured to generate the deterministic emulation model (η) from the deterministic simulation model (f(x,y)).

Preferably, the emulation module (124) is further configured to determine data representing at least one control design point (x) and data representing at least one geologic random point (y) and select from the at least one geologic random point (y), at least one sample geologic random point (yₛₐₘₚₗₑ), wherein the output of the deterministic emulation model (η) is at least one output from inputs of the at least one control design point (x) and the at least one sample geologic random point (yₛₐₘₚₗₑ).

Preferably, the at least one geologic random point (y) is a set of points representing a random distribution.

Preferably, the at least one geologic random point (y) represents a parameter in a model that is difficult to measure or determine, the random distribution representing known, measured or estimated variation in the parameter.

Preferably, the emulation module (124) is further configured to update the stochastic emulation model (β), using emulation update techniques, to generate an updated stochastic emulation model (β_{new}), wherein the emulation update techniques account for the stochastic emulation model (β).

Preferably, the emulation module (124) is further configured to update the stochastic emulation model (β) by being configured to determine a new building function (γ_{new}) based on a new deterministic emulation model (η_{new}), and determine new partial outputs (γ_{new,i}) from the new building function (γ_{new}), wherein the emulation update is based on partial outputs (γ_{new,i}).

Preferably, the emulation module (124) is further configured to determine another partial output (γₛ) of the building function (γ), transmit data representing input variables for generating the partial output (γᵢ) to a processing element of a parallel processing system, and transmit data representing different input variables for generating the another partial output (γₛ) to another processing element of a parallel processing system.

Preferably, the stochastic emulation model and the deterministic emulation model are models of a simulation model of a reservoir.

Preferably, the computer system (100) is further configured to determine a new deterministic emulation model (η_{new}), by determining, by the simulation module (122), a new deterministic simulation model (f(x,y,)_{new}) from the stochastic simulation model (f(x,Y)), and determining, using the emulation module (124), a new deterministic emulation model (η_{new}) from the new deterministic simulation model (f(x,y,)_{new}).

Preferably, the emulation module (124) is further configured to generate an updated stochastic emulation model (β_{new}), based on the new deterministic emulation model (η_{new}) and a prior stochastic emulation model (β).

Preferably, the emulation module (124) is further configured to determine one or more of a new or updated building function (γ_{new}) and a new or updated partial output (γ_{new,i}).

### BRIEF DESCRIPTION OF THE DRAWINGS

The same reference number represents the same element on all drawings. It should be understood that the drawings are not necessarily to scale.

FIG. 1 shows a block diagram of an embodiment of a computer system 100 having a processor and memory for constructing statistical emulators for reservoir simulation models.

FIG. 2 shows a flowchart of an embodiment of a method 200 for generating a stochastic emulation model (β).

FIG. 3 shows a flowchart of an embodiment of a method 300 for generating a stochastic emulation model (β) from a deterministic emulation model (η).

FIG. 4 shows a flowchart of an embodiment of a method 400 for updating or generating a new stochastic emulation model (β_{new}) based on an existing stochastic emulation model (β).

FIG. 5 shows a flowchart of an embodiment of a method 300 for generating a new or updated stochastic emulation model (β_{new}) from a new or updated deterministic emulation model (η_{new}).

FIG. 6 shows an image of a comparison 600 of an embodiment of the disclosed two-stage method with a one-stage method.

FIG. 7 shows a comparison 700 of an embodiment of the disclosed two-stage method with a one-stage method in a progression over several runs.

FIG. 8 shows a graph 800 of an embodiment of the disclosed two-stage method compared with a one-stage method with respect to the number of input design points and the resulting implausibility measurements.

FIG. 9 shows another comparison 900 of an embodiment of the disclosed two-stage method with a one-stage method in a progression over several runs.

FIG. 10 shows a graph 1000 of an embodiment of a building function accounting for a single control design variable and a single geologic random variable with a uniform distribution.

FIG. 11 shows a graph 1100 of an embodiment of a building function accounting for a single control design variable and a single geologic random variable with a Gaussian distribution.

### DETAILED DESCRIPTION

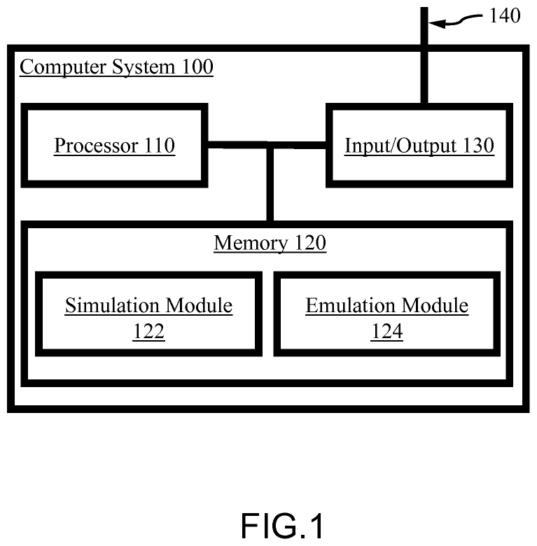

FIGS. 1-11 and the following description depict specific examples to teach those skilled in the art how to make and use the best mode of embodiments of determining emulations of simulations of reservoir models. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to generate emulations of simulations. As a result, the embodiments described below are not limited to the specific examples described below, except the claims, themselves, with express limitations.

The techniques proposed here may provide methods to build a statistical emulator for the production controls incorporating the uncertainty from the geological parameters. This may allow optimization of the controls under the geological uncertainty. Variations on the typical closed loop system include ‘little loop’ and ‘big loop’. In a little loop system, the reservoir model is a simulation model with a fixed geological grid and comparatively few, low dimensional, geological uncertainty parameters. In a big loop system, the reservoir model is a simulation model coupled to a detailed geological modelling package. In big loop there can be many more, high dimensional, geological uncertainty parameters. Statistical emulators of the kind described here can often struggle to represent many high dimensional parameters. The inventive method may employ effective parameter limiting techniques as well as other techniques to reduce the complexity of the problem, and the same principles may be extended to big loop applications.

Optimization under uncertainty either may require an optimizer capable of optimizing stochastic models or may either additionally or separately require the combination of regular deterministic optimization techniques with an auxiliary method of modelling the uncertainty. Different approaches can be taken to model uncertainty in an optimization framework. A simple approach is to use Monte Carlo simulation, in which lots of samples of the random inputs are generated and the simulation model run for each sample. This results in a set of simulation model outputs that can be interpreted using statistical techniques. This approach is straightforward to implement but may require many simulation runs to obtain accurate results. Monte Carlo simulation has been shown to be impractical in large scale reservoir simulation applications.

Bayesian optimization techniques in which an optimizer is combined with a statistical emulator, are commonly used to optimize controls for reservoir simulation models. In the Bayesian optimization setting a stochastic statistical emulator can be used to model the uncertainty. Statistical emulators are analytical functions that can approximate the response of the reservoir simulation model. This may facilitate fast evaluation of the response for large numbers of input parameters. Emulators may be built in conjunction with experimental design techniques such as Latin hypercube sampling. Experimental design techniques specify a set of inputs, referred to as design points, to the simulation model. This set of inputs may be chosen to explore the input parameter space efficiently. This can allow accurate emulators to be created with smaller numbers of runs as input. Once an emulator has been set up and verified for a given reservoir simulation model it may be used in place of the simulation model. Fast evaluation of the emulator may lead to improved efficiency when performing history matching or when optimizing model outputs.

Emulation techniques may be extended to allow approximation of stochastic simulation models. Creating stochastic emulators may require an estimate of the mean and variance of the stochastic simulation model at each experimental design input point. Methods may make use of simple random sampling, or repetition runs, to estimate the mean and variance e.g. running the simulation model repeatedly with the same inputs. However, such simple random sampling, which is effectively a form of Monte Carlo simulation, requires a large number of samples to obtain accurate estimates of the mean and variance. This can lead to a prohibitive number of simulation runs being required when creating a stochastic emulator for a stochastic simulation model.

The methods disclosed may provide a system for constructing emulators of a stochastic reservoir simulation model where the distributions of any random variables in the model are known or can be estimated. The method may initially treat the stochastic reservoir model as a deterministic reservoir model, perhaps by including the random variables that are responsible for the stochastic nature of the model as inputs. Emulator construction techniques may be used to build an emulator for the deterministic version of the reservoir model. Samples from this first emulator may be used as inputs to build a second, stochastic, emulator for the stochastic version of the reservoir model. This emulator may show higher accuracy for the corresponding number of simulator runs than a stochastic emulator created using other techniques.

These emulators may have many and varied usages. For instance, the emulators may be used to determine the best locations on a map, representing a physical site, in which certain operations should be conducted. The operations may include, for instance, drilling to establish a well at a site, moving a well from one site to another site, determine where the faults are, determine where to inject fluids to compel underground fluids to move from the subsurface. The emulators may also provide insight into certain operating parameters, for instance, well injector pressures, producing well pressures, injector fluid flowrates, gas and oil output flowrates, and/or the like. The emulator may be used to determine parameters for maximizing certain outcomes, for instance, the amount of oil and gas produced. The emulator may be used to determine parameters for minimizing certain outcomes, such as the amount of wastewater produced.

This invention exploits the source of randomness in this case and streamlines the creation of emulators for simulation models with uncertain inputs. This results in far fewer runs being required to produce an accurate emulator. This allows the acceleration of optimization workflows for reservoir simulation models with uncertain inputs.

FIG. 1 shows a block diagram of an embodiment of a computer system 100 having a processor and memory for constructing statistical emulators for reservoir simulations models.

The computer system 100 may execute a two-stage method for generating a stochastic emulation model (β) that emulates the simulation model f(x,Y). In a first stage, a deterministic emulation model (η) may be constructed for the simulation model f(x,Y) by treating the random variables in the simulation model f(x,Y) as known quantities. The deterministic emulation model (η) may be used to generate at least one building function (γ). In a second stage, stochastic emulation model (β) may be generated for the control inputs to the simulation model using at least one building function (γ).

In various embodiments the computer system 100 may be comprised of application specific integrated circuits or may have a discrete processor and memory elements, the processor elements for processing commands from and storing data on the memory elements. The computer system 100 may be configured to store data representing parameters received from other systems representing geologic models and representative variable values.

The computer system 100 may have a processor 110, a memory 120, and an input/output 130. The memory 120 may store and/or may have integrated circuits representing, for instance, a simulation module 122 and/or an emulation module 124. In various embodiments, the computer system 100 may have other computer elements integrated into the stated elements or in addition to or in communication with the stated computer elements, for instance, buses, other communication protocols, and the like.

The processor 110 is a data processing element. The processor 110 may be any element used for processing such as a central processing unit, application specific integrated circuit, other integrated circuit, an analog controller, graphics processing unit, field programmable gate array, any combination of these or other common processing elements and/or the like. The processor 110 may have separate cores in order to facilitate parallel processing, perhaps of multiple variables simultaneously or multiple steps of the methods or module steps described in this specification.

The memory 120 is a device for electronic storage. The memory 120 may be any non-transitory storage medium and may include one, some, or all of a hard drive, solid state drive, volatile memory, integrated circuits, a field programmable gate array, random access memory, read-only memory, dynamic random-access memory, erasable programmable read-only memory, electrically erasable programmable read-only memory, and/or the like. The processor 110 may execute commands from and utilize data stored in the memory 120.

In an embodiment, the computer system 100 may be a standalone computing device, a virtual machine, and/or a cloud computing element. The computer system 100 may also communicate with a cloud computing environment. For instance, for compute intensive operations or highly parallelizable computations, the computer system 100 may communicate with external compute resources to conduct some of the methods, individual steps of the methods, routines within the steps of methods, or any combination thereof in this specification, the compute resources being, for instance, a cloud computing element, a server, other multiple processing devices, and/or external devices with graphics processor units.

The computer system 100 may be configured to store any data that will be used by the simulation module 122 and/or the emulation module 124 and may store prior iterations of simulation models or various outputs for the emulation models with respect to specific control design point and/or random geologic point values. The computer system 100 may also store any data that represents emulation instances, and sub-step emulation intermediates. While the simulation module 122 and emulation module 124 are represented as separate and discrete modules in this specification, it can be appreciated that all of the methods in this specification can be accomplished by any number of modules, including one or more discrete modules working in isolation or in concert.

For the purposes of this specification, two sets of variables may be considered. A first set of variables are control design variables (also referred to as “x”), having particular values called control design points or design values (for example, “xᵢ”). Control design variables represent quantities that can be definitively controlled and/or can be optimized. Control design variables, therefore, are not random variables in simulation modeling. For instance, in an oil and/or gas context, these variables may include, for instance variables representing a location and trajectory of a well, flowrate of water injected into an injector well, pump pressures, a pressure at the top of a producer well, flowrates, depth of a well, location of a top of a reservoir, location of a bottom of a reservoir, size of well perforations, locations of well perforations, and/or the like. In the context of shale oil production, the control design variables may include location and size of well fracture stages as well as pressure and composition of injected well fracking fluid. In an embodiment, the control design variables may be multi-dimensional, such that each value of x is a tensor of values representing measurable and/or controllable non-random conditions (e.g. in an embodiment, a single xᵢ could have one value for each of well location, drill depth, and well pressure). The control design variables may be determined by the simulation module 122, the emulation module 124, and/or may be specified by a user. Also, although the term control design variables are used to refer to the class of variables, the specific values of those control design variables used for input may vary in individual steps. For instance, the simulation may be built using different control design values from ones used in emulation. Further, within emulation, different control design values may be used for each emulation step. In alternative embodiments, the same control design values may be used for some of the steps and different control design values may be used for some of the steps.

For the purposes of explanation, x may be characterized as having index values of 1 to N, represented by the following:

X=(xᵢ;i=1, . . . ,N),

with x representing an individual control variable for the models.

Also, for purposes of explanation, a subset of x values may be used as sample control design variables, hereinafter, xₛₐₘₚₗₑ:

xₛₐₘₚₗₑ⊂X

xₛₐₘₚₗₑ=(x_{sample,f};f=1, . . . ,K)

A second set of variables are geologic random variables (from a distribution “Y” ˜P, with specific subsets referred to as “y”), having particular values called geologic random points or values (for example, “yⱼ”). The geologic random variables are random values. For each yⱼ, there may be a number of parameters each having a single value (e.g. in an embodiment, each yⱼ is a tensor having a rock porosity value, a fault location value, and rock permeability value). The geological random variables may represent quantities that have uncertain values. These are quantities that are difficult to measure or cannot be measured directly, such as subsurface parameters. Subsurface parameters may include, for instance, rock permeability, rock porosity, fault locations, facies locations, water saturation, and/or the like. The geologic random variables may be well-represented by types of random distributions, for instance, a Gaussian distribution, a Beta distribution, Triangle distribution, and Uniform distribution. The geologic random variables may be better represented by simple ranges with no specific weighting given to any particular range within the simple range, for instance, representative of a Uniform distribution. The geologic random variables may be assigned assumed values or may be based on a random distribution. Random distributions may be established by the computer system 100 based on raw data or may be received from another computer source or modules outside of those described in this specification. For example, the distribution may be defined and approximated by a large number of samples generated by a statistical method such as Markov Chain Monte Carlo or other computer source or modules outside of this specification. The ranges or distributions of the geologic random variables may be informed by realistic values typical of the conditions in the field. For instance, samples may have been taken or seismic readings may indicate particular ranges and/or distributions of values for geologic random variables. Also, although the term, geologic random variables, is used to refer to the class of variables, the specific values of those control design variables used for input may vary in individual method steps. For instance, the simulation may be built using different geologic random values from ones used in emulation. Further, within emulation, different geologic random values may be used for each emulation step. In alternative embodiments, the same geologic random values may be used for some of the steps and different geologic random values may be used for some of the steps.

For the purposes of explanation, Y is a random variable having a probability distribution, P, and y is a realization, or sample, of the random variable, Y, their relationship characterized by:

Y˜P

{y=Y}

y=(yⱼ;j=1, . . . ,M)

Also, for purposes of explanation, a subset of the y values may be used as sample geologic random variables, hereinafter, yₛₐₘₚₗₑ:

yₛₐₘₚₗₑ⊂y

yₛₐₘₚₗₑ=(y_{sample,f};f=1, . . . ,K)

All combinations of embodiments with certain values of control design variables and geologic random variables are contemplated. For instance, a simulation and emulation may be conducted with the same y values but different x values, a simulation and emulation may be conducted with the same y values and same x values, the simulation and emulation may be conducted with the same y values with the emulation being conducted with individual steps having different x values, and/or the emulation may be conducted with y values being different from those of the simulation but the x values of one of the individual steps may be the same as the x values used in the simulation, and the like. These are merely exemplary, and all combinations, including all combinations of sequential differences in values are contemplated. In an embodiment, particular x values for particular x variables may be used only once with a given y value for a particular y variable.

The simulation module 122 is a module that creates a simulation model, perhaps of an oil & gas reservoir. The simulation model may be constructed by combining simulated physics with measured or sampled geophysical data. This data may include, for instance, seismic, gravimetric and other geologic spatial measured data, as well as sample porosity, permeability, water saturation and/or other geophysical data determined, perhaps, by taking well log and well core samples.

The simulation module 122 may create a simulation model of a reservoir. In an embodiment, the simulation module 122 may identify, determine, and/or receive inputs, representing control design points and geologic random points. The inputs may be determined in advance and received by the simulation module 122 or the emulation module 124, the inputs may be determined by the simulation module 122 or the emulation module 124, or the inputs may be chosen randomly by the simulation module 122 or the emulation module 124 from a variety of pre-specified likely values, for instance, a range or probability distribution. The simulation module 122 and/or the emulation module 124 may determine a number of control design points or may receive from a user or other program a specified number of control design points. In another embodiment the emulation module 124, not the simulation module 122, generates the geologic random points and control design points. The simulation module 122 and/or the emulation module 124 may use experimental design techniques, for instance, Latin hyper cube sampling, to decide where to sample the control design points and/or the geologic random points for generating a deterministic simulation model (f(x,y)), from a stochastic simulation (f(x,Y)).

In an embodiment, the simulation module 122 may output a deterministic simulation model (f(x,y)) from values of geologic random variables and control design variables. For instance, the simulation module can generate a stochastic simulation model (f(x,Y)) which takes as inputs the distribution of Y˜P. Using some sample subset of geologic random variables, yₛₐₘₚₗₑ, the simulation module 122 can use (f(x,Y)) to generate a deterministic simulation model, f(x,yₛₐₘₚₗₑ) (hereinafter referred to as “f(x,y)”) accounting for the randomness reflected in the sample, itself.

The emulation module 124 is a module that generates emulation models. The emulation module 124 may output a deterministic emulation model (η) representing a deterministic simulation model (f(x,y)). The emulation module 124 may receive or determine a deterministic simulation model (f(x,y)), for instance, a reservoir simulation model. The emulation module 124 may use stochastic input values obtained from the deterministic emulation model (η) to build a stochastic emulation model (β). The stochastic emulation model (β) emulates the stochastic simulation model (f(x,Y)). The stochastic emulation model (β) may account for the variability in parameters represented by the geologic random variables that cannot readily be measured or are measured with accompanying uncertainty.

In order to generate the stochastic emulation model (β), the emulation module 124 may initially generate or receive a deterministic emulation model (η) based on a deterministic simulation model (f(x,y)) that is received by the emulation module 124. The emulation module 124 may determine control design points and geologic random points for generating the initially generated deterministic emulation model (η) using a design technique, for instance, Latin hypercube sampling. Geologic random points may be chosen by choosing values within the random distribution of each geologic random variable considered or the emulation module 124 may use all of the values of the geologic random variables considered by the model. In an embodiment, the simulation module 122 and/or the emulation module 124 may use stratified sampling to determine samples. For instance, the choice of the random variables to sample may be random or may be chosen to best represent the distribution, perhaps by selecting the geologic random values at uniform intervals within the distribution. The simulation module 122 may run the simulation model (f(x,y)) at every combination of chosen control design point and chosen geologic random variable point or range of geologic random points. A trend fitting technique may be used by the emulation module 124 to generate the deterministic emulation model (η) from the response data from the simulation model (f(x,y)), the responses being the outputs of the simulation model (f(x,y)) corresponding to the control design points and the geologic random points. The curve fitting technique to generate the deterministic emulation model (η) may be, for instance, Bayes linear emulation methodology, Polynomial Chaos Expansion, Gaussian process regression (also known as “Kriging”), and/or techniques commonly used in the art. Other curve fitting techniques to establish emulators are well-known in the art. The deterministic emulation model may be a function of x and y (e.g. may be η(x,y)). Because the determinations of outputs of the simulation model are relatively independent of one another, the simulation module may parallelize these determinations using, for instance, any parallel processing cores, perhaps transmitting the source data to multiple cores with shared local memory. Similarly, the emulation module 124 may parallelize the determinations of the emulation from any partial outputs.

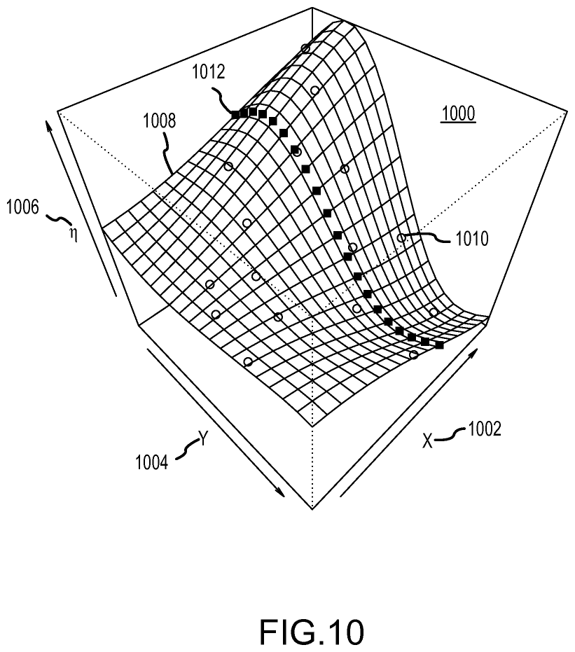

In order to generate the stochastic emulation model (β) from the deterministic emulation module (η), the emulation module 124 may strategically or randomly select certain geologic random points for each geologic random variable considered in order to make a sample set, yₛₐₘₚₗₑ. Geologic random points may be chosen by choosing values within the random distribution of each geologic random variable considered. These values may be representative of the random distribution, P. The choice of the random variables to sample may be random with or may be chosen to best represent the distributions for each random variable, P, perhaps by selecting the geologic random values at uniform intervals (e.g. y=5, y=10, y=15 . . . ) or uniform discrete sequential steps (e.g. y₅, y₁₀, y₁₅ . . . ) between values within the distribution. The emulation module 124 may use a subset or all of the control design points, xₛₐₘₚₗₑ. In an embodiment, xₛₐₘₚₗₑ is just x, representing that all values of x are sampled. The emulation module 124 may use the same or different control design values as were used in the creation of the deterministic emulation model (η). The emulation module 124 may take, as input to the deterministic emulation model (η), the sample control design values, xₛₐₘₚₗₑ, and the sample geologic random values, yₛₐₘₚₗₑ, and generate output from the deterministic emulation model (η). The emulation module 124 may determine which control design points to compare with which geologic random points using an experimental design technique, for instance, Latin Hypercube sampling. A curve fitting technique may then be used to generate building functions (γ) that represent the relationship between the outputs of the deterministic emulation model (η), the sample control design values (xₛₐₘₚₗₑ) and the sample geologic random values (yₛₐₘₚₗₑ), the building functions (γ) perhaps being continuous functions. For purposes of demonstration, if the emulation module 124 were to generate the building functions (γ) from a single geologic random variable and a single control design variable (see e.g. FIG. 10), the building functions (γ), representing the response to these variable values from the deterministic emulation model (η), the building function (γ) may appear as a surface relative to the control design values and the geologic random values.

The emulation module 124 may use the building functions (γ) to determine the stochastic nature of an outputted stochastic emulation model (β). For each design control point, the emulation module 124 may generate a partial building function (hereinafter, “γᵢ”) for each design control point value with respect to all of the geologic random values. To be clear, all of the geologic random values may include all of the values of y, not merely the y values in the set of yₛₐₘₚₗₑ. For instance, with each specified combination of control design variables, xᵢ, all relevant values of geologic random variables are inputted to generate outputs γᵢ. These outputs may yield a specific range of output values, representing the partial output, γᵢ, for each value of xᵢ (xᵢ representing a single combination of control design values of a single control design point) with respect to all specified y values. The y values chosen, again, may be the entire set of y values, perhaps representing a probability distribution.

This partial emulation function may be characterized by:

γᵢ comprises the entire set of γ(xᵢ, yᵢ) for all j=1 to M.

The emulation module 124 may determine a trend for each range of partial output values (γᵢ) associated with each of the xᵢ values in relation to all of the y values. These trends may include establishing a distribution for all values in γᵢ. For instance, for each xᵢ, a partial output γᵢ range of values may be characterized as having an average partial output value (average γᵢ) or may be characterized as having a standard deviation of a partial output value (standard deviation of γᵢ) with respect to all compared values of the geologic random points.

The average of a partial output value can be characterized by:

$${\overline{γ}}_{i} = \frac{1}{M} {\sum }_{j = 1}^{M} γ ( {x}_{i ′} {y}_{j} )$$

The variance of a partial output value can be characterized by:

$$var ( {γ}_{i} ) = \frac{1}{M - 1} {\sum }_{j = 1}^{M} {( γ ( {x}_{i ′} {y}_{j} ) - {\overline{γ}}_{i} )}^{2}$$

Other potentially useful trends include, for instance, the minimum or maximum of the partial outputs (min(γᵢ) and/or max(γᵢ)), and the standard deviation of the partial outputs (SD(γᵢ)).

In embodiments where the building function (γ) is used alternatively or additionally to the partial outputs (γᵢ) to generate the stochastic emulation model (β), similar trends may be determined for building function (γ) (e.g. γ̅, var(γ), min(γ), and/or max(γ), SD(γ)).

When all of the xᵢ values are assessed against all of the y values, a series of partial output values (γᵢ) with associated trends and/or distributions may be generated (e.g. average of γᵢ and/or standard deviation of γᵢ). The emulation module 124 may generate a single stochastic emulation model from the collection of partial output values (γᵢ) using existing emulation techniques (e.g. the Stochastic Bayes Linear Emulator, Stochastic Kriging/Gaussian process regression). The emulation module 124 may also combine partial outputs (γᵢ) with associated distributions to form a single stochastic emulation model (β) using existing emulation techniques. The stochastic emulation model (β) may represent the stochastic behavior of the geologic random variables and the effects of this variability on the output. In some embodiments, the emulation module 124 may determine the stochastic emulation model (β) directly from the partial outputs (γᵢ) without any consideration of trends of the partial outputs (γ). In embodiments where the emulation module 124 uses the building function (γ), alternatively or in addition to, the partial outputs, the emulation module 124 may use trends of the building function (γ) or may not utilize trends of the building function (γ).

Because the partial outputs may be calculated relatively independently of one another, the emulation module 124 may assign each determination of a partial output (γᵢ) to a different processing element or set of different processing elements. For instance, the emulation module 124 may transmit a determination of a first partial output to a specific processing core or segment of parallel processing cores with shared local memory, and the emulation module 124 may transmit a determination of a second partial output to a different specific processing core or different segment of parallel processing cores with different shared local memory, potentially to hasten the determinations of the partial outputs.

In another embodiment, the emulation module 124, may generate the stochastic emulation model (β) from the building function (γ) overall, instead of or in addition to from partial outputs (γᵢ) of the building function (γ). In this regard, all of the sampled geologic random variable values may be assessed against all of the control design points in the deterministic emulation model (η) to output a single building function (γ), accounting for all relationships between the control design points and the geologic random points.

In various embodiments, the emulation module 124 may take further responsive action, for instance, determining pump pressures and/or transmitting commands to pumps to alter applied pressures.

In various embodiments, the simulation module 122 and/or the emulation module 124 may be incorporated into a software package for modeling reservoir behavior.

In an embodiment, the emulation module 124 may use an existing stochastic emulation model (β), the existing stochastic emulation model (β) generated by the emulation module 124, as input to create a new or updated stochastic emulation model (β_{new}) from a new or updated deterministic simulation model (f(x,y)_{new}). The simulation module 122 may receive or determine new control design points, perhaps chosen by methods already specified for choosing control design points. The simulation module 122 may receive or determine geologic random points, these perhaps the same as before or chosen again using methods described in this specification. The simulation module 122 may run the simulation with the new design points and the new geologic random points chosen. The simulation module 122 may output a new and/or updated deterministic simulation model (f(x,y)_{new}) function based on the new points from the stochastic simulation model (f(x,Y)). The emulation module 124 may receive the new or updated deterministic simulation model function (f(x,y)_{new}) and update or replace the existing deterministic emulation model (η), perhaps using sequential emulation techniques to form a new or updated deterministic emulation model (η_{new}). These sequential emulation techniques may use prior iteration(s) of emulation models to generate the next iteration of emulation models. The emulation module 124 may receive or determine either new or existing design control points and geologic random points (perhaps in the manners already disclosed). The emulation module 124 may input those new or existing design control points and geologic random points into the updated or new deterministic emulation model (η_{new}). The emulation module 124 may use test control design points and test geologic random points, perhaps the same ones or different ones, as it did in the example of generating the original building functions (γ), perhaps varying some of the elements in the manner disclosed with respect to the building functions (γ). The emulation module 124 may determine updated or new partial outputs (γ_{new,i}) using methods that were used to determine γᵢ and/or new or updated trends representing the partial outputs and/or overall building function (e.g. γ̅_{new,i}, var(γ_{new,i}), max(γ_{new,i}), min(γ_{new,i}), SD(γ_{new,i}), γ̅_̅{̅n̅e̅w̅}̅, var(γ_{new}), min(γ_{new}), and/or max(γ_{new})) as shown in the methods with respect to γᵢ. The emulation module 124 may combine values of γ_{new,i}, and associated trends using existing stochastic emulation techniques to yield a new or updated stochastic emulation model (β_{new}). In updating or making new models, the simulation module 122 and/or the emulation module 124 may use some elements of existing models and/or some new elements. In updating or making new models, the simulation module 122 and/or the emulation module 124 may use known simulation and/or emulation update techniques in order to update existing models instead of or in addition to generating new models.

In another embodiment, the emulation module 124 may update the existing stochastic emulation model (β) from a new and/or updated building function (γ_{new}) overall, instead of or in addition to from the new and/or updated partial outputs (γ_{new,i}) of the new and/or updated building function (γ_{new}). In this regard, all of the sampled geologic random variable values may be assessed against all of the control design points in the new and/or updated deterministic emulation model (η_{new}) to output a single new and/or updated building function (γ_{new}), accounting for all relationships between the control design points and the geologic random points. This new and/or updated building function (γ_{new}) can be used to generate a new and/or updated stochastic emulation model (β_{new}) in isolation or in concert with any, some combination, or all of the new and/or updated partial outputs (γ_{new,i}), trends in either or both of the new and/or updated building function (γ_{new}) and the new and/or updated partial outputs (γ_{new,i}), and/or a prior stochastic emulation model (β).

The input/output 130 is a device used to communicatively couple the data computer system 100 to external compute elements. The input/output 130 is capable of connecting the computer system 100 to external elements, using known technologies, the external elements including, for instance, universal serial bus, Prolink, serial communication, serial advanced technology attachments, HPC type connections, Gigabit Ethernet, infiniband, and/or the like. The input/output 130 may have a communicative coupler 140. The communicative coupler 140 is used to couple the computer system 100 with components external of the computer system 100, for instance, with external compute devices used in mining or oil and gas applications for drilling, mapping, or determining well locations.

### Flowcharts

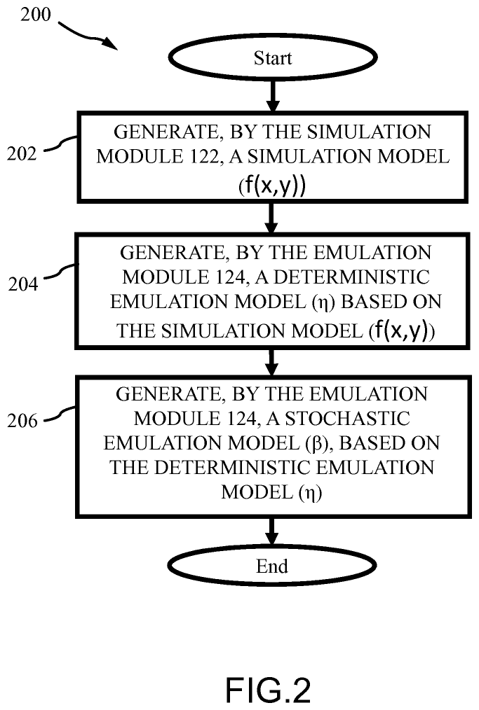

FIGS. 2-5 show flowcharts of embodiments of methods for generating stochastic emulators. The methods disclosed in the flowcharts are non-exhaustive and merely demonstrate potential embodiments of steps and orders. The methods must be construed in the context of the entire specification, including elements disclosed in descriptions of FIG. 1, the computer system 100 disclosed in FIG. 1, and/or the simulation module 122 and/or the emulation module 124 of FIG. 1.

FIG. 2 shows a flowchart of an embodiment of a method 200 for generating a stochastic emulation model (β). The simulation module 122 and the emulation module 124 may be embodiments of the simulation module 122 and the emulation module 124 disclosed in FIG. 1, although any suitable simulation module 122 and emulation module 124 may be employed in alternative embodiments. All methods for accomplishing these steps disclosed in this specification are contemplated, including all of the capabilities of the computer system 100 and its modules.

Step 202 is generate, by the simulation module 122, a deterministic simulation model (f(x,y)). The simulation module 122 may determine the deterministic simulation model (f(x,y)) by providing sample values for Y to the stochastic simulation model (f(x,Y)), in order to deterministically characterize the stochastic simulation model (f(x,Y)). The simulation module 122 may use any, some or all of the methods presented with respect to the capabilities of the simulation module 122 in order to generate the deterministic simulation model (f(x,y)).

Step 204 is generate, by the emulation module 124, a deterministic emulation model (η) based on the deterministic simulation model (f(x,y)). The emulation module 124 may use any, some or all of the methods presented with respect to the capabilities of the emulation module 124 in order to generate the deterministic emulation model (η) from the deterministic simulation model (f(x,y)).

Step 206 is generate, by the emulation module 124, a stochastic emulation model (β), based on the deterministic emulation model (η). The emulation module 124 may use any, some or all of the methods presented with respect to the capabilities of the emulation module 124 in order to generate the stochastic emulation model (β) from the deterministic emulation model (η).

In an embodiment, each of the steps of the method shown in FIG. 2 is a distinct step. In another embodiment, although depicted as distinct steps in FIG. 2, steps 202-206 may not be distinct steps. In other embodiments, the method shown in FIG. 2 may not have all of the above steps and/or may have other steps in addition to or instead of those listed above. The steps of the method 200 shown in FIG. 2 may be performed in another order. Subsets of the steps listed above as part of the method shown in FIG. 2 may be used to form their own method. The steps of method 200 may be repeated in any combination and order any number of times, for instance, continuously looping in order to continuously generate new models.

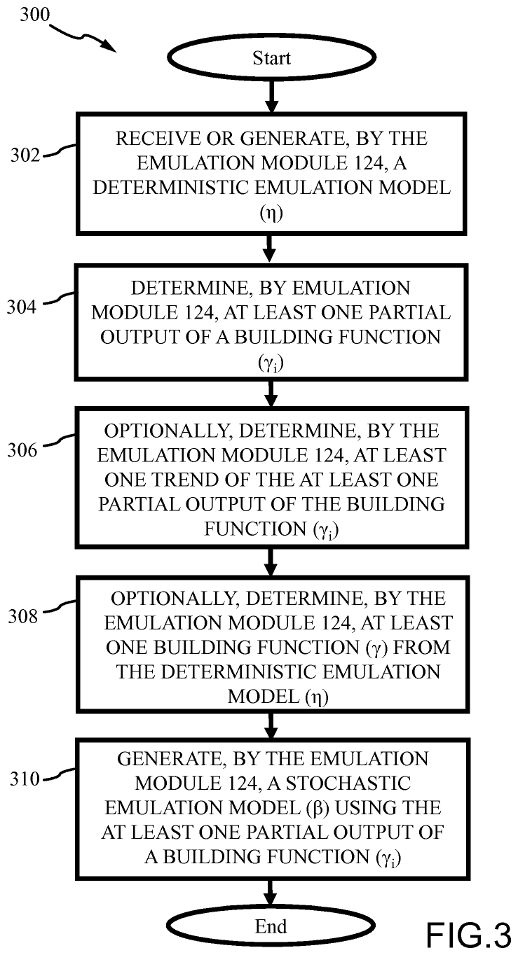

FIG. 3 shows a flowchart of an embodiment of a method 300 for generating a stochastic emulation model (β) from a deterministic emulation model (η). The simulation module 122 and the emulation module 124 may be embodiments of the simulation module 122 and the emulation module 124 disclosed in FIG. 1, although any suitable simulation module 122 and emulation module 124 may be employed in alternative embodiments. All methods for accomplishing these steps disclosed in this specification are contemplated, including all of the capabilities of the computer system 100 and its modules. The method 300 may be an embodiment of method step 206 in FIG. 2.

Step 302 is receive or generate, by the emulation module 124, a deterministic emulation model (η). The emulation module 124 may use any, some or all of the methods presented with respect to the capabilities of the emulation module 124 in order to generate the deterministic emulation model (η) from the simulation model (f(x,y)) or may simply receive the deterministic emulation model (η) already determined from another source.

Step 304 is determine, by emulation module 124, at least one partial output of a building function (γ). The emulation module 124 may use any, some or all of the methods presented with respect to the capabilities of the emulation module 124 in order to determine the at least one partial output of a building function (γᵢ). Step 306 may be conducted in addition to step 304 or step 306 and 304 may be performed in the alternative.

Step 306 is optionally, determine, by the emulation module 124, at least one trend of the at least one partial output of the building function (γ). These trends may represent the nature and effect of the underlying random distribution of the geologic random variables. The emulation module 124 may use any, some or all of the methods presented with respect to the capabilities of the emulation module 124 in order to determine the at least one trend of the at least one partial output of the building function (γᵢ). In various embodiments, these trends can represent any number of relationships. Embodiments of the at least one trend of the at least one partial output of a deterministic emulation model (γᵢ) may include, for instance, a minimum partial output (min(γᵢ)), a maximum partial output (max(γᵢ)), an average partial output (γ̅ᵢ) a variance of a partial output (var(γᵢ)), and a standard deviation (SD(γᵢ)), but the specification contemplates all trend and distribution determination techniques known in the art. The emulation module 124 may alternatively or additionally determine trends of the building function (γ) (e.g. one or more of an average of the building function (γ), a variance of the building function (var(γ)), a minimum of the building function min(γ), and the maximum of the building function max(γ)), itself and may do so in addition to or in the alternative to determining the at least one trend of the partial output (γᵢ).

Step 308 is optionally, determine, by the emulation module 124, at least one building function (γ) from the deterministic emulation model (η). The emulation module 124 may use any, some or all of the methods presented with respect to the capabilities of the emulation module 124 in order to determine the at least one building function (γ) from the deterministic emulation model (η). In an embodiment, the at least one building function (γ) may be determined from one or more of the at least one partial output (γᵢ) that is determined in step 304 and the at least one trend of the at least one partial output (γᵢ) that is determined in step 306.

Step 310 is generate, by the emulation module 124, a stochastic emulation model (β) using the at least one partial output of a building function (γ). The emulation module 124 may alternatively or additionally generate the stochastic emulation model (β) from the building function (γ), itself, instead of or in addition to the partial outputs (γᵢ). The emulation module 124 may use any, some or all of the methods presented with respect to the capabilities of the emulation module 124 in order to generate the stochastic emulation model (β). For instance, in an embodiment, the emulation module 124 may also account for the at least one trend of the at least one partial output of a building function (γᵢ) and/or the at least one trend of a building function (γ), in generating the stochastic emulation model (β), as disclosed with respect to the capabilities of the emulation module 124.

In an embodiment, each of the steps of the method shown in FIG. 3 is a distinct step. In another embodiment, although depicted as distinct steps in FIG. 3, steps 302-310 may not be distinct steps. In other embodiments, the method shown in FIG. 3 may not have all of the above steps and/or may have other steps in addition to or instead of those listed above. The steps of the method 300 shown in FIG. 3 may be performed in another order. Subsets of the steps listed above as part of the method shown in FIG. 3 may be used to form their own method. The steps of method 300 may be repeated in any combination and order any number of times, for instance, continuously looping in order to continuously generate new models.

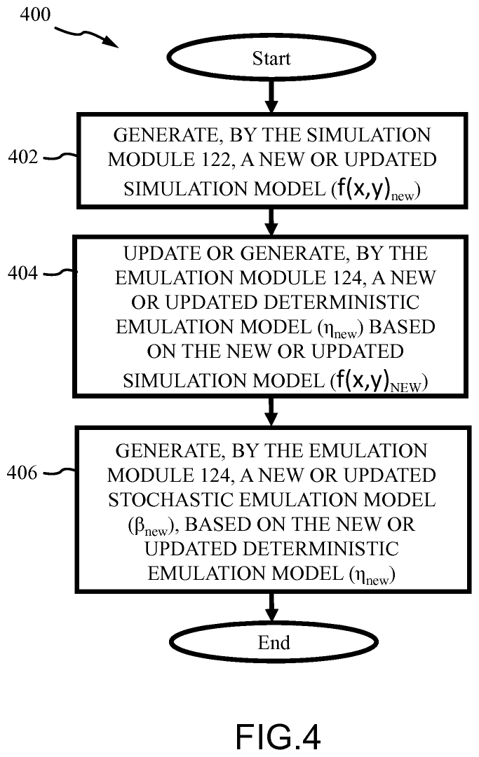

FIG. 4 shows a flowchart of an embodiment of a method 400 for updating or generating a new stochastic emulation model (β_{new}) based on an existing stochastic emulation model (β). The simulation module 122 and the emulation module 124 may be embodiments of the simulation module 122 and the emulation module 124 disclosed in FIG. 1, although any suitable simulation module 122 and emulation module 124 may be employed in alternative embodiments. All methods for accomplishing these steps disclosed in this specification are contemplated, including all of the capabilities of the computer system 100 and its modules. For the purposes of this specification, when it is stated that the model is new or updated, it is contemplated that the model may be new, may be updated, or may be both new and updated.

Step 402 is generate, by the simulation module 122, a new or updated deterministic simulation model (f(x,y)_{new}). This new or updated deterministic simulation model (f(x,y)_{new}) may be determined, by the simulation module 122, from sampling the existing stochastic simulation model, f(x,Y). The simulation module 122 may use any, some or all of the methods presented with respect to the capabilities of the simulation module 122 in order to generate the new or updated deterministic simulation model (f(x,y)_{new}).

Step 404 is update or generate, by the emulation module 124, a new or updated deterministic emulation model (η_{new}) based on the new or updated deterministic simulation model (f(x,y)_{new}). The emulation module 124 may use any, some or all of the methods presented with respect to the capabilities of the emulation module 124 in order to generate the new or updated deterministic emulation model (η_{new}) from the new or updated simulation model (f(x,y)_{new}).

Step 406 is generate, by the emulation module 124, a new or updated stochastic emulation model (β_{new}), based on the new or updated deterministic emulation model (η_{new}). The emulation module 124 may use any, some or all of the methods presented with respect to the capabilities of the emulation module 124 in order to generate the new or updated stochastic emulation model (β_{new}) from the new or updated deterministic emulation model (η_{new}).

In an embodiment, each of the steps of the method shown in FIG. 4 is a distinct step. In another embodiment, although depicted as distinct steps in FIG. 4, steps 402-406 may not be distinct steps. In other embodiments, the method shown in FIG. 4 may not have all of the above steps and/or may have other steps in addition to or instead of those listed above. The steps of the method 400 shown in FIG. 4 may be performed in another order. Subsets of the steps listed above as part of the method shown in FIG. 4 may be used to form their own method. The steps of method 400 may be repeated in any combination and order any number of times, for instance, continuously looping in order to continuously generate new models.

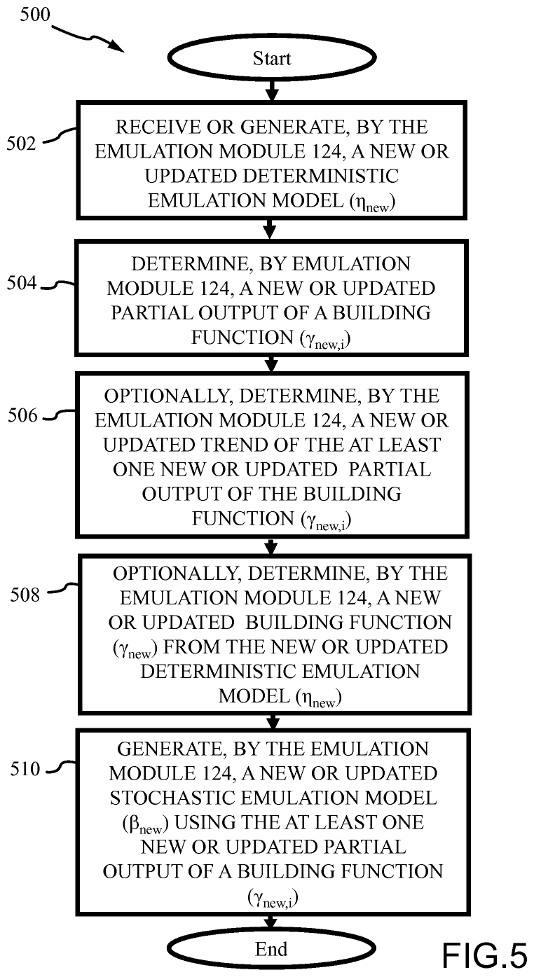

FIG. 5 shows a flowchart of an embodiment of a method 500 for generating a new or updated stochastic emulation model (β_{new}) from a new or updated deterministic emulation model (η_{new}). The simulation module 122 and the emulation module 124 may be embodiments of the simulation module 122 and the emulation module 124 disclosed in FIG. 1, although any suitable simulation module 122 and emulation module 124 may be employed in alternative embodiments. All methods for accomplishing these steps disclosed in this specification are contemplated, including all of the capabilities of the computer system 100 and its modules. The method 500 may be an embodiment of method step 406 in FIG. 4. For the purposes of this specification, when it is stated that the model is new or updated, it is contemplated that the model may be new, may be updated, or may be both new and updated.

Step 502 is receive or generate, by the emulation module 124, a new or updated deterministic emulation model (η_{new}). The emulation module 124 may use any, some or all of the methods presented with respect to the capabilities of the emulation module 124 in order to generate the new or updated deterministic emulation model (η_{new}) from the simulation model (f(x,y)) or may simply receive the new or updated deterministic emulation model (η_{new}) already determined from another source.

Step 504 is determine, by emulation module 124, at least one new or updated partial output of a building function (γ_{new,i}). The emulation module 124 may use any, some or all of the methods presented with respect to the capabilities of the emulation module 124 in order to determine the at least one new or updated partial output of a building function (γ_{new,i}). Step 506 may be conducted in addition to step 504 or step 506 and 504 may be performed in the alternative. Also, in various embodiments, the emulation module may determine the new and/or updated building function (γ_{new}) alternatively or in addition to the partial outputs (γ_{new,i}) in order to generate the new and/or updated stochastic emulation model (β_{new}).

Step 506 is optionally, determine, by the emulation module 124, at least one new or updated trend of the at least one new or updated partial output of the building function (γ_{new,i}) and/or a trend of the new building function (γ_{new}). The emulation module 124 may use any, some or all of the methods presented with respect to the capabilities of the emulation module 124 in order to determine the at least one new or updated trend of the at least one new or updated partial output of the building function (γ_{new,i}) and/or the trend of the new building function (γ_{new}). In various embodiments, these trends can represent any number of relationships, including those specified trends in other embodiments disclosed in this specification. Embodiments of the trend may include any of the trends mentioned in this specification and/or any other trends known in the art.

Step 508 is optionally, determine, by the emulation module 124, at least one new or updated building function (γ_{new}) from the new or updated deterministic emulation model (η_{new}). The emulation module 124 may use any, some or all of the methods presented with respect to the capabilities of the emulation module 124 in order to determine the at least one new or updated building function (γ_{new}) from the new or updated deterministic emulation model (η_{new}). In an embodiment, the at least one new or updated building function (γ_{new}) may be determined from one or more of the at least one partial output (γ) that is determined in step 504 and the at least one trend of the at least one partial output (γ) that is determined in step 506.

Step 510 is generate, by the emulation module 124, a new or updated stochastic emulation model (β_{new}) using the at least one new and/or updated partial output of a building function (γ_{new,i}) or the new and/or updated building function (γ_{new}), itself. The emulation module 124 may use any, some or all of the methods presented with respect to the capabilities of the emulation module 124 in order to generate the new or updated stochastic emulation model (β_{new}). For instance, in an embodiment, the emulation module 124 may additionally or as an alternative to the least one new and/or updated partial output of a building function (γ_{new,i}) account for the at least one new or updated trend of the at least one new or updated partial output of a building function (γ_{new,i}) and/or the new or updated building function (γ_{new}) in generating the new or updated stochastic emulation module (β_{new}), as disclosed with respect to the capabilities of the emulation module 124.

In an embodiment, each of the steps of the method shown in FIG. 5 is a distinct step. In another embodiment, although depicted as distinct steps in FIG. 5, steps 502-510 may not be distinct steps. In other embodiments, the method shown in FIG. 5 may not have all of the above steps and/or may have other steps in addition to or instead of those listed above. The steps of the method 500 shown in FIG. 5 may be performed in another order. Subsets of the steps listed above as part of the method shown in FIG. 5 may be used to form their own method. The steps of method 500 may be repeated in any combination and order any number of times, for instance, continuously looping in order to continuously generate new models.

### Graphs and Comparisons

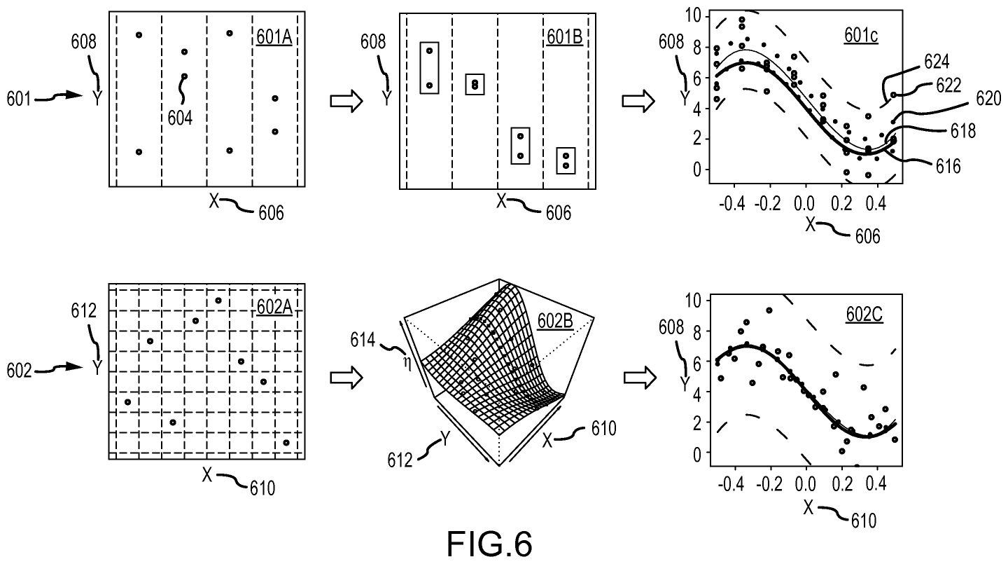

FIGS. 6-11 show graphs and comparisons explaining the methods and procedures conducted by the computer system 100 described in the specification. These graphs and comparisons demonstrate the performance and implementation of the methods and procedures conducted by the computer system 100 and its simulation module 122 and emulation module 124.

FIG. 6 shows an image of a comparison 600 of an embodiment of the disclosed two-stage method with a one-stage method. For the purposes of this specification, a one-stage method (also called a repetition or direct method) is a different method by which to generate a stochastic emulator. The one-stage method for generating a stochastic emulator has steps of using existing experimental design techniques to obtain design points, evaluating the statistical model repeatedly at each design point with respect to geologic random points to obtain a mean and variance of the stochastic simulation model output, and the mean and variance of the resulting simulation outputs are used to generate the stochastic emulation model. This may require considerably more iterations of evaluation in order to yield a stochastic emulation that sufficiently represents a simulation than are required by the two-stage method disclosed. The one-stage method may also generate results of greater variation than the two-stage method.

The comparison 600 has a first row 601 representing a one-stage method for generating a stochastic simulation, the first row having images 601A, 601B, and 601C. The second row 602 represents the two-stage method presented in the specification, the second row 602 having images 602A, 602B, and 602C. It should be noted that the comparison 600 deals only with a single dimension of each of a control design variable and a geologic random variable.

In the images, the respective models have abscissa 606 and 610, representing the values of the control design variables and ordinates 608 and 612 representing the values of geologic random variables. In image 602B, the ordinate is the deterministic emulator response. The surface is the output of the first (deterministic) emulator. The highlighted squares show the partial response or partial output (γᵢ) at a single control design point.

In 601A, the single stage method is shown, where points are chosen randomly and are not representative of the span of geologic random variable values and control design values. It can be seen in 602A, that an experimental design method, in this instance, Latin hypercube sampling, allows for a more representative series of outputs to be generated.

In 601A, it can be seen that the trends are determined based on averaging values of the independent control design point values of only the random samples. This fails to account for relationships between the control design points, effectively treating the control design points as unrelated. The stochastic relationships derived also demonstrate independence from one another and are less representative of a real system. In 602B, it can be seen that the building function (the surface generated from the output points) may provide a relationship between the outputs of different control design point inputs. In doing so, the stochastic relationships are more representative of the simulation model the stochastic emulation model is intended to mimic. Image 602B may be an embodiment of the graph in FIG. 10, and more specific details of the figure are treated there.

601C and 602C show a true function mean of the simulation model 616, an emulator predicted function mean 618, uncertainty in emulator mean 620, a plurality of output points 622, and an emulator uncertainty for overall stochastic function 624. It can be seen in the image 602C, representing the results of the two-stage method, and the image 601C, representing the one-stage method, that the two-stage method may be superior to the one-stage method in terms of limiting uncertainty in the results and tracking the simulation model results.

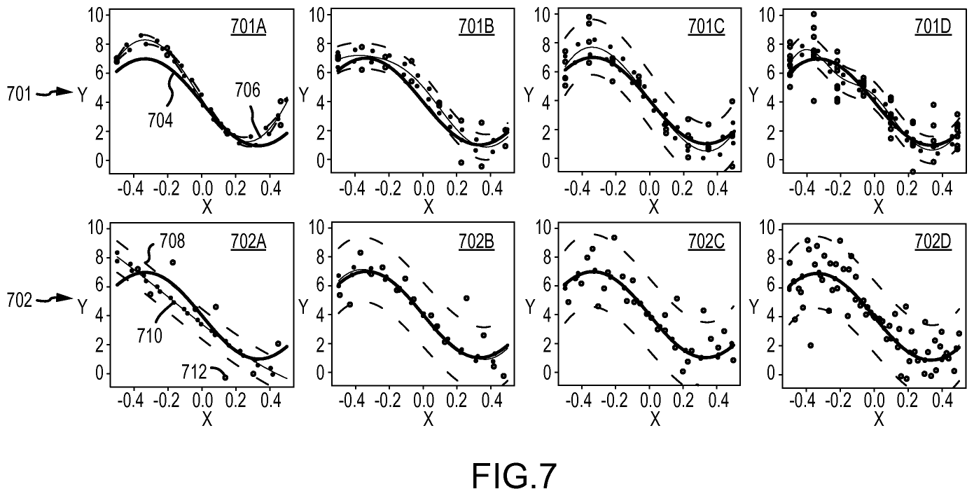

FIG. 7 shows a comparison 700 of an embodiment of the disclosed two-stage method with a one-stage method in a progression over several runs. The embodiment has a first row 701, representing values for the one-stage model, having images 701A, 701B, 701C, and 701D. The embodiment has a second row 702, representing values for the two-stage model having images 702A, 702B, 702C, and 702D. The images 701A and 702A represent the models using 8 design points. The images 701B and 702B represent the models using 16 design points. The images 701C and 702C represent the models using 32 design points. The images 701D and 702D represent the models using 64 design points. Each image has a true function mean 704, an emulator predicted function mean 706, an emulator uncertainty for the overall stochastic function 708, emulator uncertainty in the mean 710, and a number of design point function values 712. It can be readily seen that the two-stage stochastic model yields an emulator predicted function mean 706 that converges quickly to the true function mean 704 and does so considerably faster than the one-stage method.

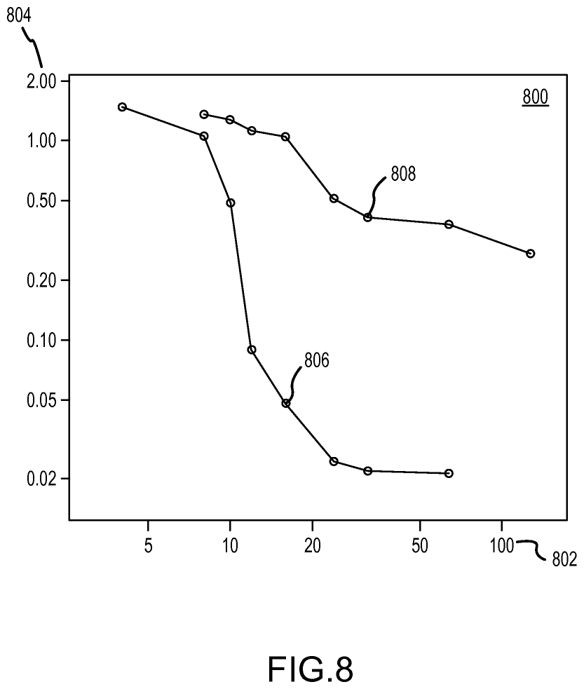

FIG. 8 shows a graph 800 of an embodiment of the disclosed two-stage compared with a one-stage method with respect to the number of input design points and the resulting implausibility measurements. The graph 800 represents one control design input and one geologic random variable.

Mean implausibility may represent a measurement of emulator prediction accuracy. For the purposes of this figure, the mean implausibility is determined by a relationship characterized by:

$$I ( x ) = \frac{( \overline{F ( x )} - {E ( θ ( x ) )}^{2}}{var ( θ ( x ) )} \qquad$$

In this relationship F̅(̅x̅)̅ represents the true mean of the simulator value, and θ is the stochastic emulator being tested.

The comparison 800 has an abscissa 802 representing a number of input design points, an ordinate 804 representing a mean implausibility, a two-stage method line 806, and a one-stage method line 808. It can be seen that the implausibility reduces very quickly for a two-stage model when compared with a one-stage model. Also, the two-stage method may plateau at a level of error that may be representative of numerical precision errors in the emulation module used, so the error shown may not be an inherent flaw of the method itself.

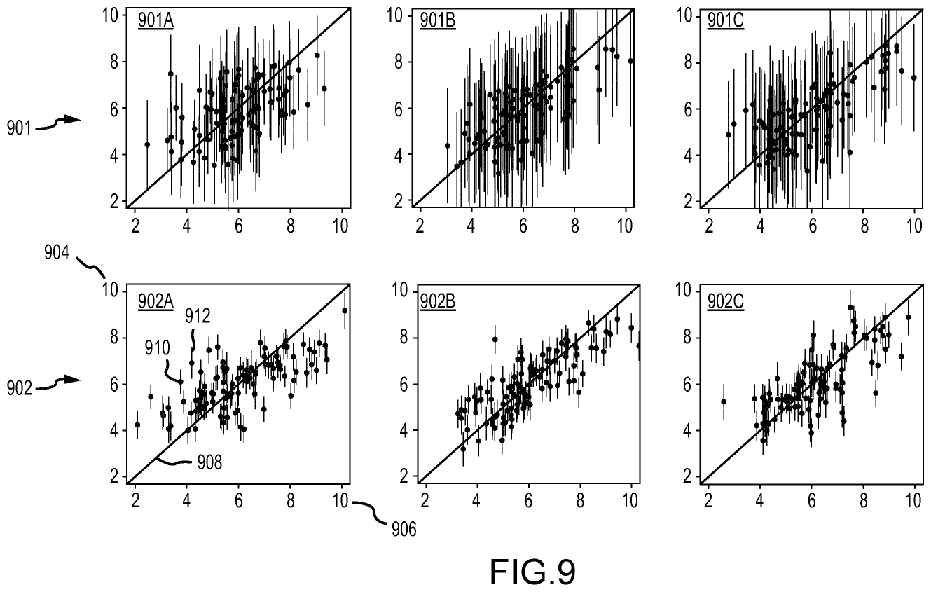

FIG. 9 shows another comparison 900 of an embodiment of the disclosed two-stage method with a one-stage method in a progression over several runs. Comparison 900 may represent a higher dimensional problem with eleven control design inputs and two geologic random variables. The comparison 900 has two rows. A first row 901 shows results of a one-stage model, the first row 901 having images 901A, 901B, and 901C. A second row 902 shows results of a two-stage model, the second row having images 902A, 902B and 902C. The images 901A and 902A represent results from 81 runs. The images 901B and 902B represent results from 161 runs. The images 901C and 902C represent results from 241 runs. Each image has an abscissa 906, representing a true response, and an ordinate 904, representing an emulator estimated response. Each image has an equality line 908, representing the location where the true response and the emulator estimated response are the same, perhaps representing an ideal situation. Each graph has emulator predicted results 910 and emulator prediction uncertainty 912. The emulator prediction uncertainty 912 in this embodiment shows twice the standard deviation above and below the prediction. It can be seen that the two-stage method creates better results that approach the true results and present results with far less variance, showing the method tracks the true values well.

FIG. 10 shows a graph 1000 of an embodiment of a building function accounting for a single control design variable and a single geologic random variable with a uniform distribution. In this graph, an embodiment is show in which the geologic random values that are used to generate a partial building function output are uniformly distributed. The graph 1000 has an abscissa 1002 (representing control design point values, x), a second abscissa 1004 (representing geologic random point values, y), an ordinate 1006 (representing a response of a deterministic emulation model), a surface 1008 (representing the building function output), an input 1010 (representing one control design point and one geologic random point), and a series of outputs from the deterministic emulation model across all values of the geologic random variable 1012 (representing a partial output). By creating the partial outputs and/or an intermediate building function, it can be seen that the original simulation model may be well-represented, as may be the stochastic variability in the outputs of the random distribution based geologic random variables. These partial outputs and/or building functions may be used to generate the stochastic emulation model.

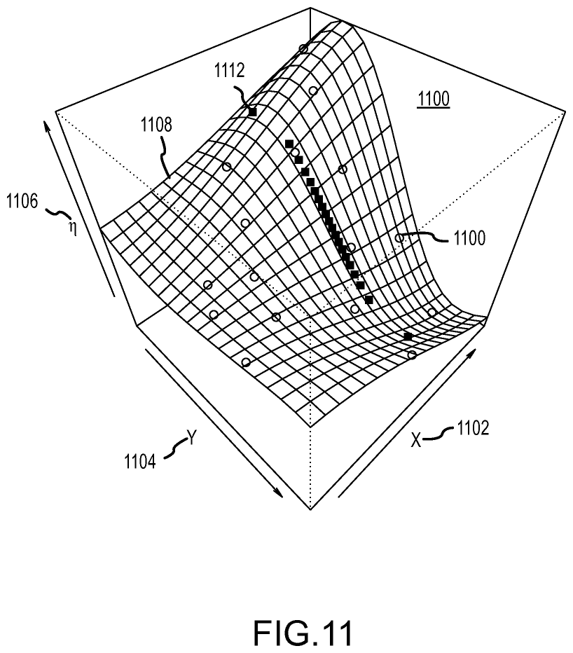

FIG. 11 shows a graph 1100 of an embodiment of a building function accounting for a single control design variable and a single geologic random variable with a Gaussian distribution. In this graph, an embodiment is show in which the geologic random values that are used to generate a partial building function output are normally distributed, based on a Gaussian distribution model. The graph 1100 has an abscissa 1102 (representing control design point values, x), a second abscissa 1104 (representing geologic random point values, y), an ordinate 1106 (representing a response of a deterministic emulation model), a surface 1108 (representing the building function output), an input 1110 (representing one control design point and one geologic random point), and a series of outputs from the building function across all values of the geologic random variable 1112 (representing a partial output). By creating an intermediate building function, it can be seen that the original simulation model may be well-represented, as may be the stochastic variability in the outputs of the random distribution based geologic random variables.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description. When specific numbers representing parameter values are specified, the ranges between all of those numbers as well as ranges above and ranges below those numbers are contemplated and disclosed.

Thus, although specific embodiments are described herein for illustrative purposes, various equivalent modifications are possible within the scope of the present description, as those skilled in the relevant art will recognize. The teachings provided herein can be applied to other methods and apparatuses for determining reservoir models, and not just to the embodiments described above and shown in the accompanying figures. Accordingly, the scope of the embodiments described above should be determined from the following claims.

We claim:

1. A method for generating a stochastic emulation model, using a computer (100) having a processor (110) configured to execute commands stored on a non-transitory memory element (120), the non-transitory memory element (120) having an emulation module (124), comprising:
generating, by the emulation module (124), a stochastic emulation model (13) from the output of a deterministic emulation model CO.

2. A method as claimed in claim 1, the generating a stochastic emulation model (β) from the output of a deterministic emulation model (η), comprising, determining, by the emulation module (124), a partial output (γᵢ).

3. A method as claimed in claim 2, the generating a stochastic emulation model (β) from the output of a deterministic emulation model (η) further comprising, determining, by the emulation module (124), at least one building function (γ) based on one or more of sample outputs of the deterministic emulation model (η) and the partial output (γᵢ).

4. A method as claimed in claim 2, the determining a partial output (γᵢ) comprising, determining the partial output (γᵢ) by aggregating all outputs of the deterministic emulation model (η) from inputs of a single control design point (xᵢ) and all geologic random points of all geologic random variables (Y) used in the stochastic emulation model (β), wherein the generating, by the emulation module (124), a stochastic emulation model (β) from the output of a deterministic emulation model CO comprises using, by the emulation module (124), the partial output (γᵢ) to generate the stochastic emulation model (β).

5. A method as claimed in claim 3, the generating a stochastic emulation model (β) from the output of a deterministic emulation model (η), further comprising, determining, by the emulation module (124), a trend of the partial output (γᵢ), wherein the generating, by the emulation module (124), a stochastic emulation model (β) from the output of a deterministic emulation module (η) comprises using, by the emulation module (124), the trend of the partial output (γᵢ) to generate the stochastic emulation model (β).

6. A method as claimed in claim 5, wherein the trend of the partial output (γ₁) is one or more of an average of the partial output (γ̅ᵢ), a variance of the partial output (var(γᵢ), a standard deviation of the partial output (SD(γᵢ)), a maximum of the partial output (max(γᵢ)), and a minimum of the partial output (min(γᵢ)).

7. A method as claimed in claim 5, determining, by the emulation module (124), at least one building function (γ), further comprising, accounting for the trend of the partial output (γᵢ).

8. A method as claimed in claim 3, the generating a stochastic emulation model (β) from the output of a deterministic emulation model (η) further comprising accounting for a trend in building function (γ) when determining, by the stochastic emulation module (124), the stochastic emulation model (β) based on the building function (γ).

9. A method as claimed in claim 1, the method for generating a stochastic emulation model (β) further comprising generating, by a simulation module (122), a deterministic simulation model (f(x,y)) from a stochastic simulation model (f(x,Y)) by providing fixed samples, (yₛₐₘₚₗₑ), for the random variables (Y) to the stochastic simulation module (f(x,Y)).

10. A method as claimed in claim 9, the method for generating a stochastic emulation model (β) further comprising generating, by the emulation module (124), the deterministic emulation model (η) from the deterministic simulation model (f(x,y)).

11. A method as claimed in claim 2, further comprising:
determining or receiving, by the emulation module (124), data representing at least one control design point (x) and data representing at least one geologic random point (y); and
selecting, by the emulation module (124), from the at least one geologic random point (y), at least one sample geologic random point (yₛₐₘₚₗₑ),
wherein the output of the deterministic emulation model (η) is at least one output from inputs of the at least one control design point (x) and the at least one sample geologic random point (yₛₐₘₚₗₑ).

12. A method as claimed in claim 11, wherein the at least one geologic random point (y) is a set of points representing a random distribution.

13. A method as claimed in claim 12, wherein the at least one geologic random point (y) represents a parameter in a model that is difficult to measure or determine, the random distribution representing known, measured or estimated variation in the parameter.

14. A method as claimed in claim 1, the method further comprising:
updating, by the emulation module (124), the stochastic emulation model (β), using emulation update techniques, to generate an updated stochastic emulation model (β_{new}), wherein the emulation update techniques account for the stochastic emulation model (β).

15. A method as claimed in claim 14, the updating, by the emulation module (124), the stochastic emulation model (β) further comprising:
determining, by the emulation module (124), a new building function (γ_{new}) based on a new deterministic emulation model (η_{hew});
determining, by the emulation module (124), new partial outputs (γ_{new,i}) from the new building function (γ_{new});
wherein the stochastic emulation model (β) is updated based on the partial outputs (γ_{new,i}).

16. A method as claimed in claim 3, further comprising:
determining, by the emulation module (124), another partial output (γₛ) of the building function (γ),
wherein the determining, by the emulation module (124), a partial output (γᵢ) of the building function (γ), further comprises transmitting, by the emulation module (124), data representing the building function (γ) and data representing input variables for generating the partial output (γᵢ) to a processing element of a parallel processing system, and wherein the determining, by the emulation module (124), another partial output (γₛ) of the building function (γ) further comprises transmitting, by the emulation module (124), data representing the building function (γ) and data representing different input variables for generating the another partial output (γₛ) to another processing element of a parallel processing system.

17. A method as claimed in claim 1, wherein the stochastic emulation model (β) and the deterministic emulation model (η) are models of a simulation model of a reservoir.

18. A method as claimed in claim 9, further comprising determining, by the emulation module (124), a new deterministic emulation model (η_{new}), by determining, by the simulation module (122), a new deterministic simulation model (f(x,y,)_{new}) from the stochastic simulation model (f(x,Y)), and determining, using the emulation module (124) a new deterministic emulation model η_{new}) from the new deterministic simulation model (f(x,y,)_{new}).

19. A method as claimed in claim 18, further comprising generating, by the emulation module (124) an updated stochastic emulation model (β_{new}), based on the new deterministic emulation model (η_{new}) and a prior stochastic emulation model (β).

20. A method as claimed in claim 19, wherein the generating, by the emulation module (124) an updated stochastic emulation model (β_{new}), based on the new deterministic emulation model (η_{new}), further comprises, determining one or more of a new or updated building function (γ_{new}) and a new or updated partial output (γ_{new,i}).

21. A computer system (100) for generating a stochastic emulation model, having a processor (110) configured to execute commands stored on a non-transitory memory element (120), the non-transitory memory element (120) having an emulation module (124), the emulation module configured to:
generate a stochastic emulation model (β) from the output of a deterministic emulation model (m).

22. A computer system (100) as claimed in claim 21, the emulation module (124) further configured to determine a partial output (γᵢ).

23. A computer system (100) as claimed in claim 22, the emulation module (124) further configured to determine at least one building function (γ) based on one or more of sample outputs of the deterministic emulation model (η) and the partial output (γᵢ).

24. A computer system (100) as claimed in claim 22, the emulation module (124) further configured to:
generate the partial output (γᵢ) by aggregating all outputs of the deterministic emulation model (η) from inputs of a single control design point (xᵢ) and all geologic random points of all geologic random variables (y) used in the stochastic emulation model (β); and
generate the stochastic emulation model (β) based on the partial output (γᵢ).

25. A computer system (100) as claimed in claim 23, the emulation module (124) further configured to:
determine, by the emulation module (124), a trend of the partial output (γᵢ); and
generate the stochastic emulation model (β) based on the trend of the partial output (γᵢ).

26. A computer system (100) as claimed in claim 25, wherein the trend of the partial output (γᵢ) is one or more of an average of the partial output (γ̅ᵢ), a variance of the partial output (var(γᵢ), a standard deviation of the partial output (SD(γᵢ)), a maximum of the partial output (max(γᵢ)), and a minimum of the partial output (min(γᵢ).

27. A computer system (100) as claimed in claim 25, the emulation module (124) further configured to determine at least one building function (γ) based on the trend of the partial output (γᵢ).

28. A computer system (100) as claimed in claim 23, the emulation module (124) further configured to determine the stochastic emulation model (β) based on one or more of the building function (γ) and a trend in the building function (γ).

29. A computer system (100) as claimed in claim 21, further comprising a simulation module (122), the simulation module (122) configured to generate a deterministic simulation model (f(x,y)) from a stochastic simulation model (f(x,Y)) by providing fixed samples, (yₛₐₘₚₗₑ), for the random variables (Y) to the stochastic simulation module (f(x,Y)).

30. A computer system (100) as claimed in claim 29, the emulation module (124) further configured to generate the deterministic emulation model (η) from the deterministic simulation model (f(x,y)).

31. A computer system (100) as claimed in claim 22, the emulation module (124) further configured to:
determine data representing at least one control design point (x) and data representing at least one geologic random point (y); and
select from the at least one geologic random point (y), at least one sample geologic random point (yₛₐₘₚₗₑ),
wherein the output of the deterministic emulation model (η) is at least one output from inputs of the at least one control design point (x) and the at least one sample geologic random point (yₛₐₘₚₗₑ).

32. A computer system (100) as claimed in claim 31, wherein the at least one geologic random point (y) is a set of points representing a random distribution.

33. A computer system (100) as claimed in claim 32, wherein the at least one geologic random point (y) represents a parameter in a model that is difficult to measure or determine, the random distribution representing known, measured or estimated variation in the parameter.

34. A computer system (100) as claimed in claim 21, the emulation module (124) further configured to:
update the stochastic emulation model (β), using emulation update techniques, to generate an updated stochastic emulation model (β_{new}), wherein the emulation update techniques account for the stochastic emulation model (β).

35. A computer system (100) as claimed in claim 34, the emulation module (124) further configured to update the stochastic emulation model (β) by being configured to:
determine a new building function (γ_{new}) based on a new deterministic emulation model (η_{new}); and
determine new partial outputs (γ_{new,i}) from the new building function (γ_{new});
wherein the emulation update is based on partial outputs (γ_{new,i}).

36. A computer system (100) as claimed in claim 33, the emulation module (124) further configured to:
determine another partial output (γₛ) of the building function (γ);
transmit data representing input variables for generating the partial output (γᵢ) to a processing element of a parallel processing system; and
transmit data representing different input variables for generating the another partial output (γₛ) to another processing element of a parallel processing system.

37. A computer system (100) as claimed in claim 21, wherein the stochastic emulation model (β) and the deterministic emulation model (η) are models of a simulation model of a reservoir.

38. A computer system (100) as claimed in claim 29, the computer system (100) further configured to determine a new deterministic emulation model (η_{new}), by determining, by the simulation module (122), a new deterministic simulation model (f(x,y,)_{new}) from the stochastic simulation model (f(x,Y)), and determining, using the emulation module (124), a new deterministic emulation model (η_{new}) from the new deterministic simulation model (f(x,y,)_{new}).

39. A computer system (100) as claimed in claim 38, the emulation module (124) further configured to generate an updated stochastic emulation model (β_{new}), based on the new deterministic emulation model (η_{new}) and a prior stochastic emulation model (β).

40. A computer system (100) as claimed in claim 39, the emulation module (124) further configured to determine one or more of a new or updated building function (γ_{new}) and a new or updated partial output (γ_{new,i}).
